(19) United States
(12) Patent Application Publication
(10) Pub. No.: US 2008/0000949 A1
(43) Pub. Date: Jan. 3, 2008

(54) Method of Joining Using Reactive Multilayer Foils With Enhanced Control of Molten Joining Materials

(76) Inventors: Jiaping Wang, College Park, MD (US); Omar Knio, Timonium, MD (US); Timothy P. Weihs, Baltimore, MD (US); Etienne Besnoin, Baltimore, MD (US)

Correspondence Address: PATENT DOCKET ADMINISTRATOR;LOWENSTEIN SANDLER PC, 65 LIVINGSTON AVENUE, ROSELAND, NJ, 07068, US

(21) Appl. No.: 11/835,818

(22) Filed: Aug. 8, 2007

Related U.S. Application Data
(62) Division of application No. 10/898,650, filed on Jul. 23, 2004, now abandoned.
(63) Continuation-in-part of application No. 10/844,816, filed on May 13, 2004.
(63) Continuation-in-part of application No. 10/761,688, filed on Jan. 21, 2004, now abandoned.
Application No. 10/761,688 is a division of application No. 09/846,486, filed on May 1, 2001, now Pat. No. 6,736,942.
(60) Provisional application No. 60/489,378, filed on Jul. 23, 2003.
(60) Provisional application No. 60/469,841, filed on May 13, 2003.
(60) Provisional application No. 60/475,830, filed on Jun. 4, 2003.
(60) Provisional application No. 60/201,292, filed on May 2, 2000.

(51) Int. Cl. B23K 20/02; B23K 20/16

(52) U.S. Cl. 228/115

(57) ABSTRACT

In accordance with the invention, bodies of materials are joined by disposing between them a reactive multilayer foil and one or more layers of meltable joining material such as braze or solder. The bodies are pressed together against the foil and joining material, and the foil is ignited to melt the joining material. The pressing is near the critical pressure and typically produces a joint having a strength of at least 70-85% the maximum strength producible at practical maximum pressures. Thus for example, reactively formed stainless steel soldered joints that were heretofore made at an applied pressure of about 100 MPa can be made with substantially the same strength at a critical applied pressure of about 10 kPa. Advantages of the process include minimization of braze or solder extrusion and reduced equipment and processing costs, especially in the joining of large bodies.

### CROSS REFERENCE TO RELATED APPLICATIONS

This application is a divisional of U.S. patent application Ser. No. 10/898,650, filed on Jul. 23, 2004, titled “Method of Joining Using Reactive Multilayer Foils With Enhanced Control of Molten Joining Materials,” which in turn claims the benefit of U.S. Provisional Application Ser. No. 60/489,378 filed by Jiaping Wang et al. on Jul. 23, 2003, titled “Methodology of Controlling Flow of Molten Solder or Braze in Reactive Multilayer Joining”.

This application is also a continuation-in-part of U.S. patent application Ser. No. 10/844,816 filed by Jiaping Wang et al. on May 13, 2004, titled “Nanostructured Soldered or Brazed Joints Made With Reactive Multilayered Foils,” which in turn claims the benefit of two U.S. Provisional Applications: 1) Ser. No. 60/469,841 filed by Etienne Besnoir et al. on May 13, 2003, titled “Method of Controlling Thermal Waves In Reactive Multilayer Joining and Resulting Product,” and 2) Ser. No. 60/475,830 filed by Jiaping Wang et al. on Jun. 4, 2003, titled “Microstructure of Solder or Braze in Joints Made With Freestanding Reactive Multilayer Foils”.

This application is also a continuation-in-part of U.S. patent application Ser. No. 10/761,688 filed by T. Weihs et al. on Jan. 21, 2004, titled “Freestanding Reactive Multilayer Foils,” which is a divisional of U.S. patent application Ser. No. 09/846,486 filed on May 1, 2001, titled “Freestanding Reactive Multilayer Foils,” which in turn claims the benefit of U.S. Provisional Application Ser. No. 60/201,292 filed by T. Weihs et al. on May 2, 2000, titled “Reactive Multilayer Foils”. U.S. application Ser. Nos. 10/898,650; 60/489,378; 10/844,816; 60/469,841; 60/475,830; 10/761,688; 09/846,486; and 60/201,292 are hereby incorporated herein by reference.

### GOVERNMENT INTEREST

The United States Government has certain rights in this invention pursuant to Award DM1-0115238 supported by NSF.

### BACKGROUND OF THE INVENTION

The joining of components of the same or different materials is fundamental in the manufacture of a wide variety of products ranging from large ships and airplanes to tiny semiconductor and optical devices. Joining by brazing or soldering is particularly important in the assembly of products composed of metal parts and the fabrication of electronic and optical devices.

Traditionally, soldered or brazed products are made by sandwiching a braze or solder between mating surfaces of the respective components and heating the sandwiched structure in a furnace or with a torch. Unfortunately, these conventional approaches often expose both the components and the joint areas to deleterious heat. In brazing or soldering, temperature-sensitive components can be damaged, and thermal damage to the joint may necessitate costly and time consuming anneals. Large coefficient of thermal expansion mismatches (CTE mismatches) can cause delamination or other damage. The alternative of law temperature joining typically produces weaker joints.

Reactive multilayer foils described in U.S. Pat. No. 6,736,942 issued to T. Weihs et al. on May 18, 2004, can be used as heat sources to effect joining with highly localized heating. The reactive foil is made up of alternating layers selected from materials that will react with one another in an exothermic and self-propagating reaction. Upon reacting the foil supplies highly localized heat energy that may be applied to joining layers. If a joining material (braze or solder) is used, the foil reaction can supply enough heat to melt the joining material, which upon cooling will form a strong bond joining bulk bodies of material.

Joining bodies using reactive multilayer foils typically involves disposing between the bodies a reactive multilayer foil and one or more layers or coating of meltable joining material, pressing the bodies together at a high applied pressure against the foil and the joining material and initiating a self-propagating chemical reaction through the foil to melt the joining material.

While this process works well and can minimize deleterious heating of the bodies, it has been observed in some applications that molten joining material escapes laterally through the joint leaving a joining layer that is undesirably thin upon cooling and an undesirable external residue of joining material. It has also been noted that the pressures usually used in this process (tip to 100 MPa) present difficulties when very large components need to be joined. Loading large components with high pressures is difficult and requires large, expensive equipment. Accordingly there is a need for improved methods of joining products by reactive multilayer foils that provide high joint strength, increased control over the behavior of the joining material, and increased convenience of use.

### SUMMARY OF THE INVENTION

The present inventors have determined that, in the joining of bodies of material by reactive multilayer foils, there exists a critical applied pressure that will provide near maximal joint strength as compared to the strength produced by substantially higher pressures. Moreover they have further discovered that, within limits, the critical applied pressures can be reduced by increasing the volume of melting material and/or the duration of the melting.

Thus in accordance with the invention, bodies of materials are joined by disposing between them a reactive multilayer foil and one or more layers of meltable joining material such as braze or solder. The bodies are pressed together against the foil and joining material, and the foil is ignited to melt the joining material. The pressing is near the critical pressure and typically produces a joint having a strength of at least 70-85% the maximum strength producible at practical maximum pressures. Thus for example, reactively formed stainless steel soldered joints that were heretofore made at an applied pressure of about 100 MPa can be made with substantially the same strength at a critical applied pressure of about 10 kPa. Advantages of the process include minimization of braze or solder extrusion and reduced equipment and processing costs, especially in the joining of large bodies.

### BRIEF DESCRIPTION OF THE DRAWINGS

The nature, advantages and various additional features of the invention will appear more fully upon consideration of the illustrative embodiments now to be described in detail in connection with the accompanying drawings. In the drawings:

FIG. 1 is a schematic drawing of a self-propagating reaction in a multiplayer foil, showing a cross-sectional view of the atomic and thermal diffusion;

FIG. 2 is a schematic drawing showing the reactive joining of two components using a reactive multiplayer foil and two solder or braze layers with an applied pressure;

FIG. 3 is a schematic drawing illustrating reactive joining of Au-coated stainless steel components using Incusil coated Al/Ni foils and two AuSn or AgSn solder layers;

FIG. 4a through 4b are images of SEM micrographs of stainless steel components joined using reactive Al/Ni foil (100 μm thick) and two free-standing AuSn solder (25 μm thick) layers under applied joining pressure of (a) 10 kPa. Here the thickness of the solder layer remains constant at 25 μm before and after soldering. (b) 60 MPa. Note that most of the AuSn solder flows out of the joint and the thickness of the solder layer is only about 5 μm;

FIGS. 5a through 5c are images of fracture surfaces of the stainless steel joints made with reactive Al/Ni foils (100 μm thick) and AuSn solder layers (25 μm thick), obtained by optical stereomicroscopy;

FIG. 5a depicts a joint that was formed under applied pressure of 2 kPa and shows partial wetting of the Au-coated stainless steel specimens and shear strength of 8 MPa. All the solder material remained in the joining area;

FIG. 5b is a joint was formed under applied pressure of 10 kPa and shows full wetting of the Au-coated stainless steel specimens and shear strength of 50 MPa. All the solder material remained in the joining area;

FIG. 5c is a joint was formed under applied pressure of 30 MPa and shows full wetting of the Au-coated stainless steel specimens and shear strength of 50 MPa. There was a large amount of solder that flowed out of the joining area;

FIG. 6a is a drawing of an experimental setup for interface thermal resistance measurement, one reactive foil and two free-standing solder layers were put between Ti and SiC blocks;

FIG. 6b is a schematic drawing showing the calculation of interface thermal resistance using the temperature gradients within each component and the temperature difference at the interface;

FIG. 7 is a drawing of temperatures at the surface of Ti and SiC blocks clamped at different pressures. Interfacial thermal resistance can be calculated from the temperature difference at the interface, temperature gradient in one component, and the thermal conductivity of this component;

FIG. 8 schematically shows reactive joining of Au-coated stainless steel and Al components using Incusil coated Al/Ni foils and two AuSn solder layers;

FIG. 9 is a diagram of shear strength of stainless steel joints and Al alloy joints as a function of applied joining pressure;

FIG. 10a is an image of a stainless steel joint, showing full wetting and;

FIG. 10b is an image of an Al alloy joints, showing partial wetting, both made with reactive Al/Ni foils (100 μm thick) and AuSn solder layers (25 μm thick) under applied pressure of 10 kPa, obtained by optical stereomicroscopy;

FIG. 11 schematically illustrates reactive joining of Au-coated stainless steel components using Incusil coated Al/Ni foils. The Incusil coating serves as the braze material and there is no free-standing solder or braze layer;

FIG. 12 is a diagram of shear strength of stainless steel joints made with Al/Ni foils and AuSn or AgSn solder (25 μm thick) or Incusil braze (1 μm) as a function of applied joining pressure, suggesting that the value of critical applied pressure is dependent on the properties and geometries of the solder or braze materials;

FIGS. 13a and 13b are images of fracture surfaces of the stainless steel joints made with reactive Al/Ni foils (150 μm thick) and Incusil braze (1 μm thick), obtained by optical stereomicroscopy;

FIG. 13a is an image of a joint which was formed under pressure of 10 kPa and shows almost no wetting of the Au-coated stainless steel specimens and an almost 0 MPa shear strength;

FIG. 13b is an image of a joint was formed under applied pressure of 6 MPa and shows full wetting of the Au-coated stainless steel specimens and a high shear strength of 80 MPa;

FIG. 14 schematically depicts an Au plated stainless steel component joined onto an Au plated PC board using a reactive foil and solder layers;

FIG. 15 is a graphical plot of shear strengths versus applied pressure for the joined structure of FIG. 14; and

FIG. 16 is a diagram of shear strength of stainless steel joints made with reactive Al/Ni foils (100 μm) and AuSn solder (25 μm thick), shown as open circles, or Al/Ni foils (40 μm) and AgSu solder (25 μm), shown as solid circles, as a function of applied joining pressure. These two data sets suggest that the applied joining pressure needs to reach a critical value to enable enough flow of the molten AuSn or AgSn solder and to form strong joints.

It is to be understood that these drawings are for purposes of illustrating the concepts of the invention and, except for the graphs and micrographs, are not to scale.

### DETAILED DESCRIPTION

This description is divided into two parts. Part I describes and illustrates reactive foil joining, and Part II describes control of molten joining material in the joining process. References indicated by bracketed numbers are fully cited in an attached list.

I. Joining of Bodies Using Reactive Multilayer Foil

Self-propagating exothermic formation reactions have been observed in a variety of nanostructured multilayer foils, such as Al/Ni, Al/Ti, Ni/Si and Nb/Si foils. These reactions are driven by a reduction in atomic bond energy. Once the reactions are initiated by a pulse of energy, such as a small spark or a flame, atomic diffusion occurs normal to the layering.

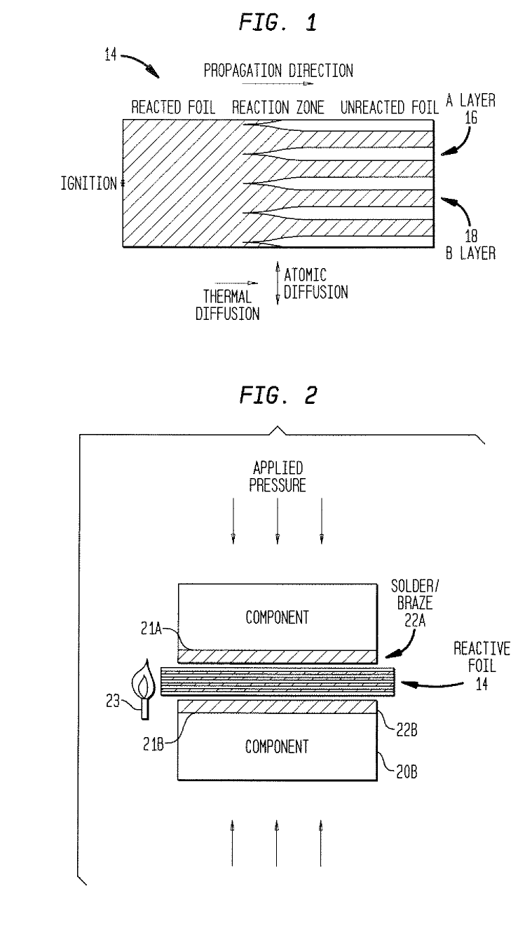

FIG. 1 schematically illustrates a multilayer reactive foil 14 made up of alternating layers 16 and 18 of materials A and B, respectively. These alternating layers 16 and 18 may be any materials amenable to mixing of neighboring atoms (or having changes in chemical bonding) in response to a stimulus. Preferably the pairs A/B of elements are chosen based on the way they react to form stable compounds with large negative heats of formation and high adiabatic reaction temperatures. A wide variety of such combinations are set forth in the above referenced U.S. patent application Ser. No. 09/846,486 incorporated herein by reference.

The bond exchange generates heat very rapidly. Thermal diffusion occurs parallel to the layering and heat is conducted down the foil and facilitates more atomic mixing and compound formation, thereby establishing a self-propagating reaction along the foil. The speeds of these self-propagating exothermic reactions are dependent on layer thickness and can rise as high as 30 m/s, with maximum reaction temperatures above 1200° C.

Reactive multilayer foils provide a unique opportunity to dramatically improve conventional soldering and brazing technologies by using the foils as local heat sources to melt solder or braze layers and thereby join components. Reactive foil soldering or brazing can be performed at room temperature and in air, argon or vacuum.

FIG. 2 schematically shows the use of multilayer reactive foil 14 to join together two components 20A and 20B. The reactive foil 14 is sandwiched between the mating surfaces 21A and 21B of the components and adjacent one or more layers or coatings 22A, 22B of braze or solder. The reactive foil 14 is preferably a freestanding reactive foil as described in the aforementioned application Ser. No. 09/846,486 but can be a coating on one or more of the components 20A, 20B. The braze or solder 22A, 22B can be freestanding or coatings on the components.

Once the components, foil and solder or braze are assembled and pressed together, an ignition stimulus 23 is applied to foil 14 produces rapid and intense heat diffusing as a thermal wavefront through the foil.

This new reactive joining process eliminates the need for furnaces or other external heat sources. Moreover reactive joining provides very localized heating so that temperature sensitive components or materials can be joined without thermal damage. The localized heating offered by the reactive foils is also advantageous for joining materials with very different coefficients of thermal expansion, e.g. joining metal and ceramics. Typically when metals are soldered or brazed to ceramics, significant thermal stresses arise on cooling from the high soldering or blazing temperatures, because of the thermal expansion coefficient mismatch between metals and ceramics. These thermal stresses limit the size of the metal/ceramic joint area. When joining with reactive multilayers, the metallic and ceramics components absorb little heat and have a very limited rise in temperature. Only the solder or braze layers and the surfaces of the components are heated substantially. Thus CTE problems on joining and delamination problems on joining are avoided.

In addition, the reactive joining process is fast, cost-effective and results in strong and thermally-conductive joints. Substantial commercial advantages can thus be achieved, particularly for assembly of microelectronic devices.

II. Control of Molten Joining Material in the Joining Process

Previous research on joining components using reactive foils and solder or braze has suggested that under an applied pressure of 100 MPa, stainless steel specimens can be joined successfully using Al/Ni reactive foils and AuSn solder layers, with a shear strength of 50 MPa. It was also observed that there is a large amount of the AuSn solder flowing out of the joining area. The flow of molten solder out of the joint area limits the application of this method when joining components onto very delicate electronic board because the splash of solder material due to the high applied joining pressure may damage other components and circuit lines on the same board.

It was also suggested in the literature that joints with thinner solder layers can be more susceptible to thermal fatigue. If the applied pressure during joining is too high, there will be excessive flow of the molten solder or braze. Consequently, too much solder or braze will be extruded out of the joining area, resulting in a very thin solder or braze layer that can shorten the thermal fatigue and mechanical fatigue life of the joint.

It has been shown in literature that the applied pressure during both conventional joining and reactive joining affects the performance of the resulting joints. For example, when AlN components were conventionally furnace-joined using commercial solder glasses containing PbO, ZnO, B₂O₃, and SiO₂, applying a pressure of 19 kPa onto the joint assembly during the joining process enhances the viscous flow of the solder glass and helps eliminate porosity. The applied pressure can also reduce the processing time and temperature by the forced viscous flow of the solder glass.

Applied pressure also plays an important role in reactive multilayer welding processes. For example, when Zr-based bulk metallic glass samples were joined using reactive Al/Ni foils, the shear strength of the joints increased from 100 to 500 MPa as the joining pressure increased from 20 to 160 MPa. It was suggested that increasing the applied pressure during joining raises the driving force for the softened glass to flow into the cracks in the reactive foils. In this case, no solder or braze material is used and joints are formed by softening the components themselves. However, in a large variety of applications of reactive joining methods, solder or braze materials are used and joints are formed by melting the solder or braze materials and wetting onto components. The effect of applied pressure on reactive joining for these geometries has not been addressed in previous research and the nature of its effect is hard to predict.

This invention describes the methodology of controlling flow of molten solder or braze in reactive multilayer joining to improve the joining performance. We consider the applied joining pressure, the duration of melting of the solder or braze material, and the volume of molten solder or braze material in the order presented. Then we illustrate the determination of a critical applied pressure to optimize joining.

(a) Applied Joining Pressure

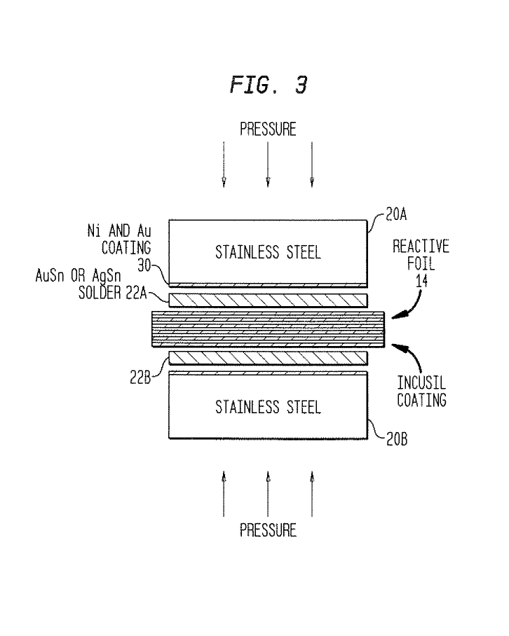

First, we describe how applied joining pressure might affect the flow of molten solder or braze material, the interfacial thermal resistance during joining and the resulting joint strength. Higher applied joining pressure can enhance the flow of molten solder or braze material, improve the wetting condition and form stronger joints. Such joints are illustrated by the joining of stainless steel components using reactive Al/Ni foils 14 and AuSn or AgSn solder layers. These joints were fabricated by stacking two AuSn or two AgSn solder layers 22A, 22B and one reactive foil between two stainless steel specimens 20A, 20B, as shown schematically in FIG. 3. The dimensions of the stainless steel specimens were 0.5 mm×6 mm×25 mm and were electroplated with a Ni and Au coating 30 to enhance bonding. These stainless steel specimens were joined at room temperature in air by igniting the reactive foils under pressure ranging from 2 kPa to 300 MPa.

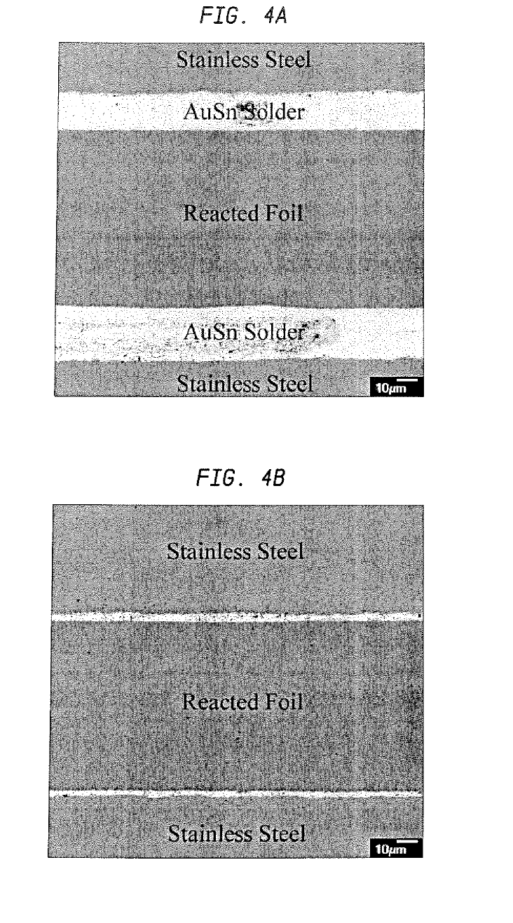

Cross sections of untested stainless steel joints made by reactive Al/Ni foils and AuSn solder layers were polished to a 1 μm finish and then characterized using scanning electron microscopy (SEM) in a JEOL microscope. FIGS. 4(a) and 4(b) show stainless steel specimens that were joined using one Al/Ni reactive foil (100 μm thick) and two free-standing AuSn solder (25 μm thick) layers under different pressures: 10 kPa and 60 MPa. When joined under low applied pressure (10 kPa), the thickness of the solder layer remains constant at 25 μm before and after soldering (FIG. 4(a)). However when joined under a much higher applied pressure (60 MPa), the AuSn solder layers decreased in thickness from 25 μm to 5 μm (FIG. 4(b)), indicating that higher applied joining pressure can enhance the flow of the molten solder, the flow of solder into cracks formed in the reacted foil and the flow out of the joining area. These flows result in a thinner solder layer. As described earlier, thin solder joints are also more susceptible to thermal fatigue and mechanical fatigue. In addition, extra solder extrusion due to high applied joining pressure can damage other devices nearby, as by creating unwanted short circuits.

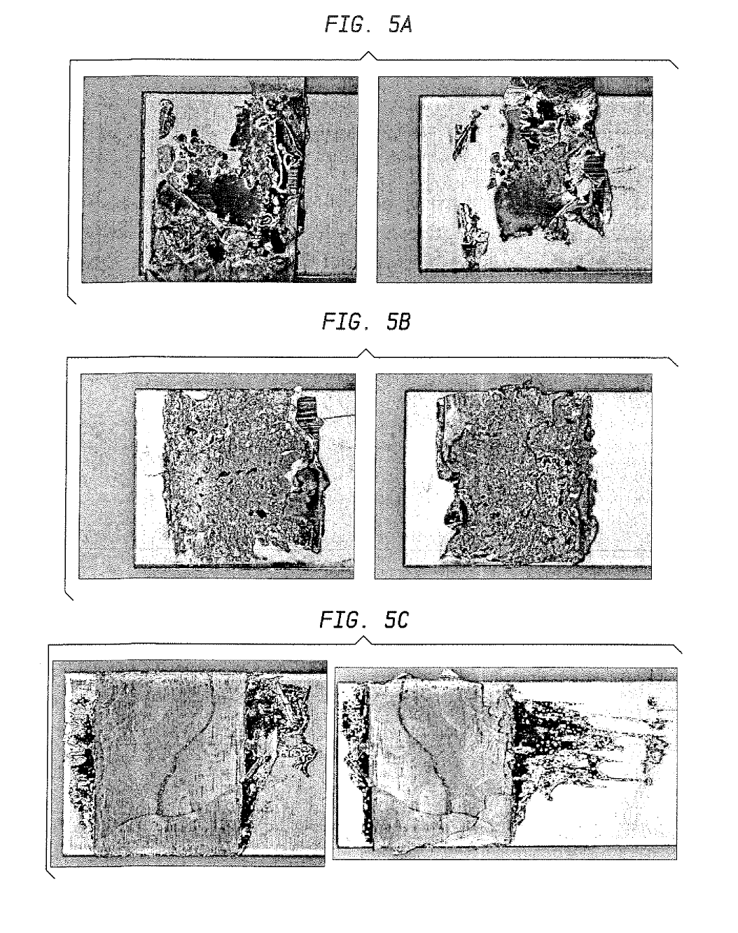

In order to determine the applied joining pressure needed to form a strong joint, stainless steel joints made with Al/Ni foils (100 μm) and AuSn solder (25 μm) layers were tested in tension at room temperature using an Instron testing machine and a crosshead speed of 0.1 mm/min. Shear strengths of these joints were obtained by dividing the maximum failure load by the joint area, and plotted as a function of applied joining pressure in FIG. 5. As the applied joining pressure increases from 2 kPa to 10 kPa, the shear strength of the joints also increases from 8 MPa to 50 MPa. The very low pressure needed in reactive joining enable its application to the joining of components over large surface areas. Further increase in the applied joining pressure does not substantially raise the shear strength of the joints. The shear strength of the joints formed under pressure between 10 kPa and 300 MPa remains approximately constant at about 50 MPa.

Some stainless steel joints were made with Al/Ni foils (40 μm) and AgSn solder (25 μm) layers. Since AgSn solder has a much lower melting point compared to AuSn solder, 40 μm thick Al/Ni foil can provide enough heat to melt all the AgSn solder. Mechanical testing on these joints shows a similar trend. The shear strength of these joints increases with increasing applied pressure until it reaches a critical value. Afterwards the shear strengths of the joints were almost constant, as shown in FIG. 5. It is expected that this variation of shear strength with applied pressure will also be seen when joining other materials or components using different kinds of reactive foils and solder or braze materials. In general, when components are joined using reactive foils and free-standing solder or braze materials, increasing the applied pressure will improve the shear strength of the resulting joints, up to some maximum value. For higher applied pressures, the measured shear strengths will remain relatively constant. In other words, the applied joining pressure needs to reach a critical value to form a strong joint.

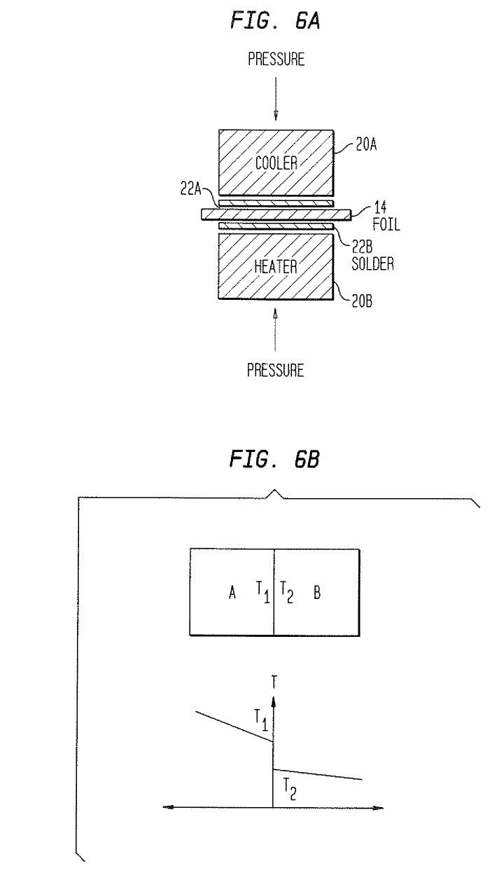

We studied the fracture surfaces of stainless steel joints made with Al/Ni foils (100 μm thick) and free-standing AuSn solder layers (25 μm) at various joining pressures using an optical stereomicroscope to directly relate the applied joining pressure and the shear strength of the joints with the flow of the molten solder or braze and the wetting of the components. As shown in FIG. 6(a), for a joint formed under an applied pressure of 2 kPa, there was partial wetting of the Au-coated stainless steel specimens and all the AuSn solder remained in the joining area. This very limited wetting results in a low shear strength for the joint, i.e. 8 MPa. As the applied pressure increases to 10 kPa, there was full wetting of the Au-coated stainless steel specimens, and all the AuSn solder still remained in the joining area (FIG. 6(b)). The shear strength of the joint increased to 50 MPa due to the full wetting. Under a much higher applied pressure, such as 30 MPa, there was also full wetting of the Au-coated stainless steel specimens but there was also significant flow of the AuSn solder out of the joining area, as shown in FIG. 6(c). This is consistent with the very thin solder layers in the stainless steel joint formed under high applied joining pressure, observed in cross-section using SEM (FIG. 4(b)). The joint in FIG. 4(b) also showed a high shear strength of about 50 MPa due to the full wetting of the sample even though the AuSn solder layer is significantly thinner compared with the joint formed tinder an applied pressure of 10 kPa. SEM micrographs of the cross section of the reactive joints and optical stereomicroscope pictures of the fracture surfaces, together with the shear strengths of these joints suggest that as the applied joining pressure increases, the flow of the molten AuSn solder is enhanced, resulting in better wetting and thus stronger joints. Meanwhile the AuSn solder extrusion out of the joining area also increases with increasing applied joining pressure, resulting in thinner solder layers more subject to thermal fatigue.

This approach can be generalized to a variety of other material systems, where other materials or components are joined using different kinds of reactive foils and solder or braze material. The applied pressure needs to approach a critical applied pressure to optimize the flow of the molten solder or braze material, so as to fully wet the specimens, thus forming strong joints. Furthermore the applied pressure should not go much above the critical pressure so that solder or braze extrusion is kept minimal and the solder or braze layer thickness is kept maximal. In this way the performance of the resulting joints can be optimized.

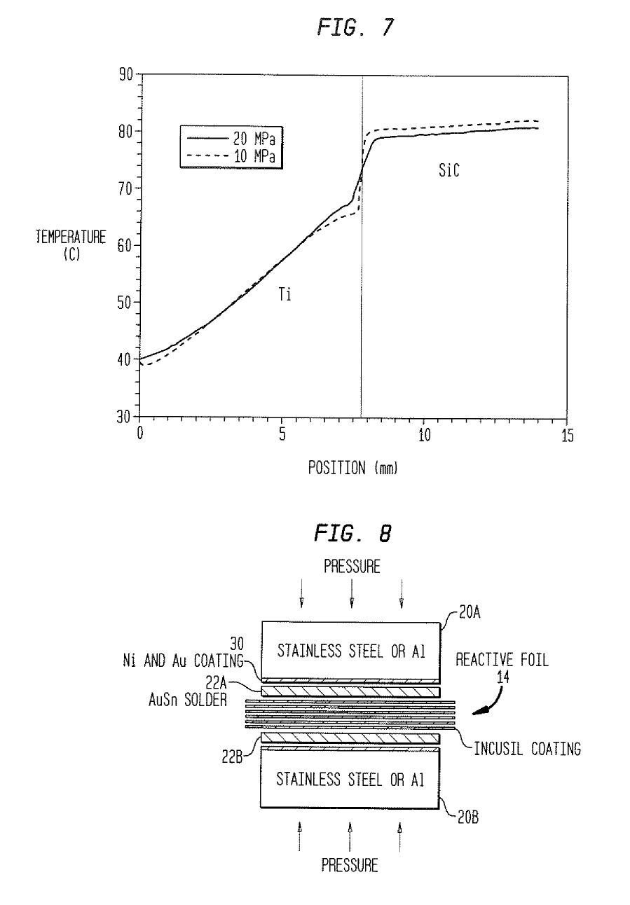

Applied joining pressure also affects the interfacial thermal resistance within the joint. Higher applied joining pressure can decrease the interfacial thermal resistance and enhance the flow of molten solder or braze, thus improving the joining performance. This is illustrated based on thermal measurement of one Ti block and one SiC block clamped between a hot plate and a cooling plate. One reactive foil 14 and two solder layers 22A, 22B were put between Ti and SiC blocks 20A, 20B, as shown in FIG. 7. Temperatures in the SiC and Ti blocks at equilibrium state were measured using an infrared camera and plotted in FIG. 8. The interface thermal resistance, R, can be expressed as,

$$R = \frac{Δ T}{Ak \frac{ⅆ T}{ⅆ x}}$$

where ΔT is the temperature difference at the interface, A is the area of the interface, k is thermal conductivity of one component, and dT/dx is the temperature gradient in this component. It was calculated that as the applied pressure increases from 10 MPa to 20 MPa, the interfacial thermal resistance decreases from 5.0 K/W to 3.4 K/W. This experiment demonstrates that higher applied joining pressure can decrease the interfacial thermal resistance, thus improve the heat transfer process and enhance the melting and flow of solder or braze.

(b) Duration of Melting of Solder or Braze

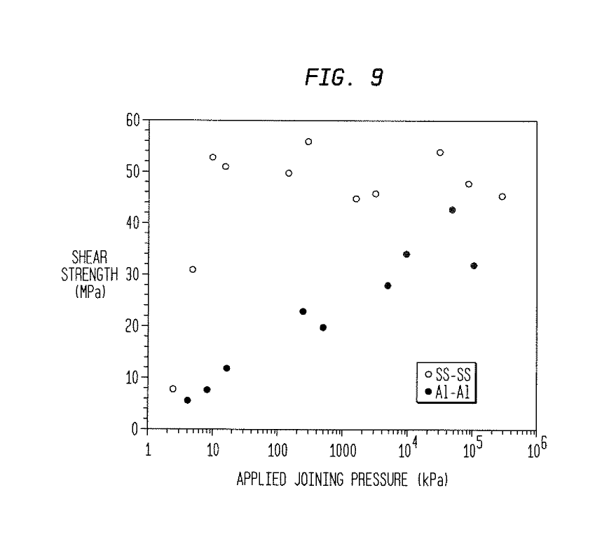

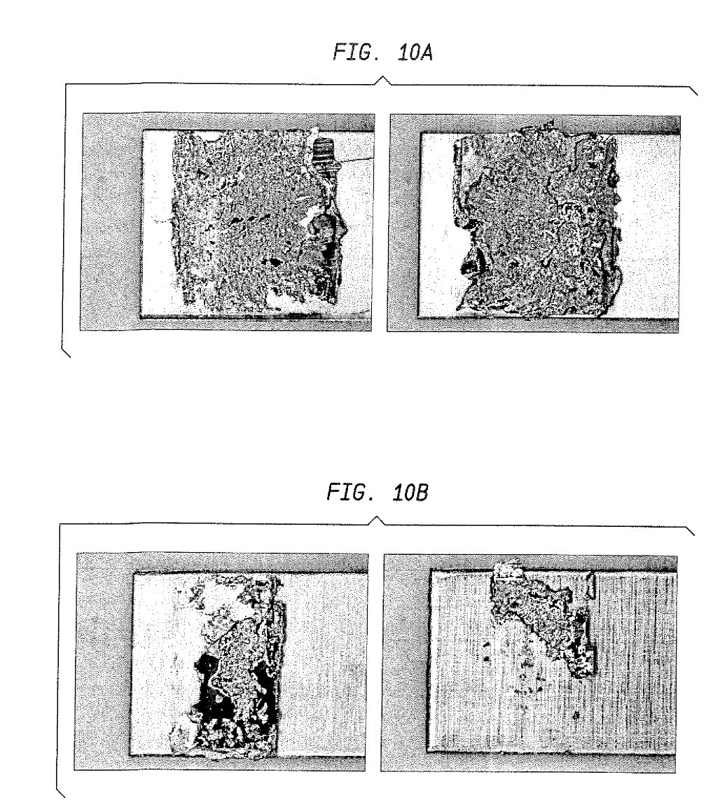

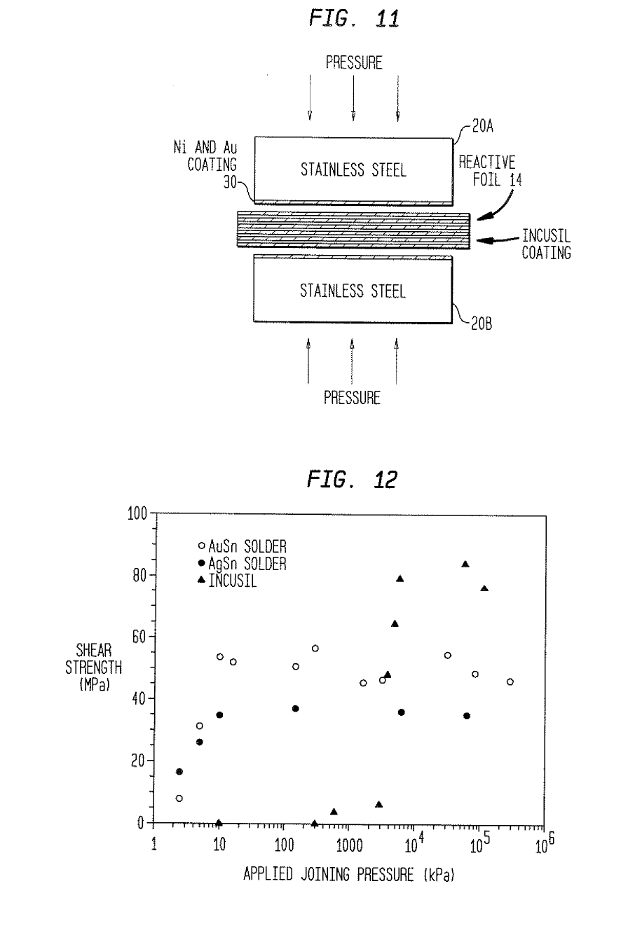

Duration of melting of solder or braze also affects the solder or braze flow and thus the reactive joining performance. For different material systems, the critical applied pressure required to enable enough solder or braze flow and thus form a strong joint depends on the duration of melting of solder or braze material. Generally longer duration of melting of solder or braze material can enhance the wetting of the components and the flow of the molten solder or braze, resulting in a lower critical applied joining pressure. This is illustrated by comparing reactive joining of Au coated stainless steel specimens (0.5 mm×6 mm×25 mm) to the reactive joining of Au coated Al alloy specimens (0.5 mm×6 mm×25 mm) using reactive Al/Ni foils (100 μm) and free-standing AuSn solder layers (25 μm), as schematically shown in FIG. 9. The shear strengths of the stainless steel joints and the Al alloy joints were plotted as a function of the applied joining pressure in FIG. 10. Under applied joining pressure of 10 kPa, stainless steel specimens can be joined successfully with a shear strength over 50 MPa, while the Al alloy joints are still quite weak with a shear strength less than 10 MPa. Fracture surfaces of a stainless steel joint and an Al alloy joint both formed under an applied pressure of 10 kPa were shown in FIG. 11. For the stainless steel joint, there was full wetting of the AuSn solder onto the stainless steel specimens, resulting in a strong joint. However for the Al alloy joint, only partial wetting onto the Al alloy specimens was observed, therefore the joint is quite weak. These different wetting conditions in stainless steel joints and Al alloy joints are due to the much higher thermal conductivity of Al alloy (167 W/mK) compared with that of stainless steel (16.2 W/mK). According to a numerical prediction of the melting of the AuSn solder layer in reactive joining of stainless steel and Al alloy specimens described in U.S. Provisional Application No. 60/469,841, the duration of melting of the AuSn solder in an Al alloy joint is only 1 ms compared to 5 ms in stainless steel joints, at the condition that the stainless steel and Al alloy specimens were joined using reactive Al/Ni foils (100 μm) and AuSn solder layers (25 μm). With such a short duration of melting of the AuSn solder material in the Al alloy joints, higher pressures are needed to enhance the flow of the molten solder, to improve the wetting of the Au coated specimen, and to fill any gaps within the joint. As shown in FIG. 10, the shear strength of the Al alloy joints gradually increases with increasing joining pressure. These results suggest that the value of the critical applied pressure is dependent on the duration of melting of the AuSn solder. Longer duration of melting of the AuSn solder can enhance the flow of the molten solder, thus result in lower critical applied pressures. It should be evident for someone skilled in the art to generalize this principle to a variety of other material systems. As suggested in U.S. Provisional Application No. 60/469,841, the duration of the melting of the solder or braze material is determined by several factors, such as geometries and properties of reactive foils, components and solder or braze materials. Therefore the flow of the molten solder or braze in reactive joining can be controlled by varying these factors and the applied joining pressure so as to maximize the performance of the reactive joints.

(c) Volume of Molten Solder or Braze

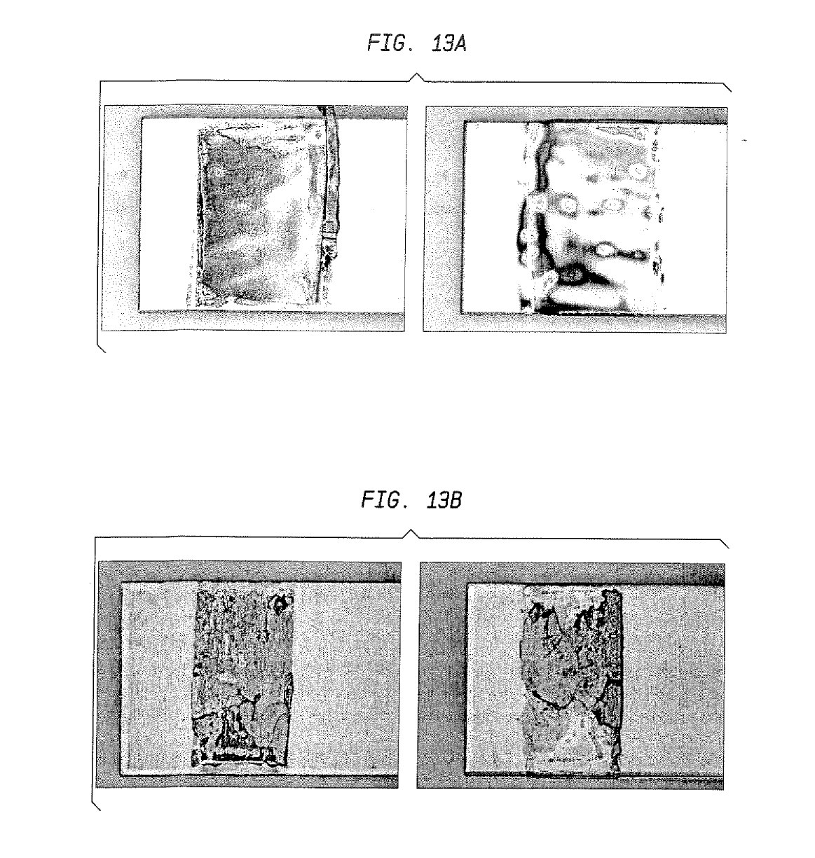

We now describe how the volumes of molten solder or braze available in reactive joints might affect the flow of solder or braze and the joining performance. Larger volumes of molten solder or braze material in reactive joints can enhance the flow of solder or braze, and thereby improve the wetting of specimens and the joining performance. Consequently a lower critical applied joining pressure is needed to form a strong joint. This is illustrated based on reactive joining of Au coated stainless steel specimens (0.5 mm×6 mm×25 mm) using Al/Ni foils and different volumes of solder or braze materials. Some stainless steel joints were made using Al/Ni foils and AuSn solder layers (25 μm), or AgSn solder layers (25 μm), as shown in FIG. 3, under applied pressure ranging from 2 kPa to 300 MPa. Some stainless steel joints were made by putting one Incusil coated reactive foil between two stainless steel samples, as shown schematically in FIG. 12. Here the 1 μm thick Incusil coating on the reactive foils serves as the braze material and no free-standing solder or braze layer is used. These samples were joined under applied pressure ranging from 10 kPa to 100 MPa and the appropriate thickness of foil was used to melt the AgSn and AuSn solders and the Incusil braze. Experimental results show that when 25 μm thick AuSn or AgSn solder materials are used, the critical applied pressure to form a strong joint is 10 kPa. While when 1 μm thick Incusil braze is used, the applied pressure needs to be as high as 6 MPa to form a strong joint, as shown in FIG. 13. Fracture surfaces of the stainless steel joints made with reactive Al/Ni foils and 1 μm thick Incusil braze were shown in FIG. 14. Joints that formed under an applied pressure of 10 kPa show almost no wetting of the Au-coated stainless steel specimens and a zero shear strength, while joints formed under an applied pressure of 6 MPa shows full wetting of the Au-coated stainless steel specimens and a very high shear strength of 80 MPa. In this joining geometry, the volume of the molten braze material is so limited that much higher pressures are needed during joining to enhance the flow of the molten braze, to fully wet the specimen, and to form strong joints, compared with other joining geometries with thicker solder or braze layers. This will also apply in other material systems. In general, larger volumes of molten solder or braze material available during joining can enhance the flow of solder or braze material, therefore a lower critical applied pressure is needed to form a good joint.

(d) Determining Critical Applied Pressure

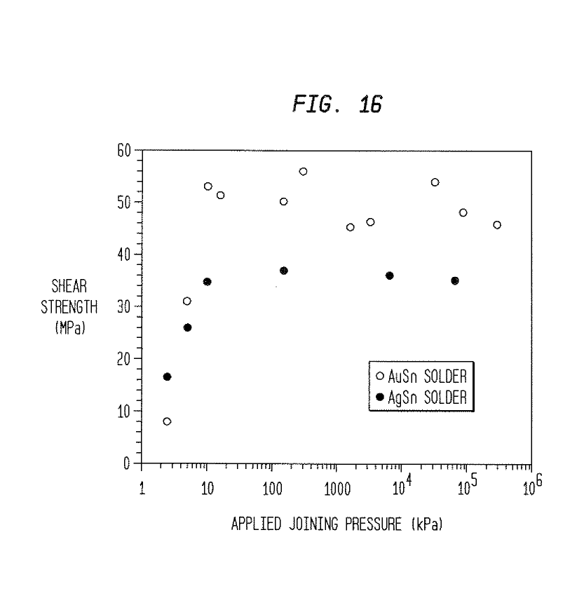

The critical applied pressure for a given application can be determined from shear strength versus applied joining pressure plots of the type shown in FIG. 16. It should be noted that the pressure is plotted on a logarithmic scale. Applicants have observed that the data points in such plots can be divided into two groups. In one group 160 corresponding to lower applied pressures, the joint strength dramatically increases with high slope as applied pressure increases. In the other group 161 corresponding to higher applied joining pressures, the joint strength increases only slightly with flat or very small slope as pressure increases. The critical applied joining pressure is the pressure at the knee of the curve between the high slope group and the low slope group. It can be more precisely determined by curve fitting, e.g. as the pressure at the point P where a fitted line 162 through the high slope group 160 intersects a fitted line 163 through the low slope group.

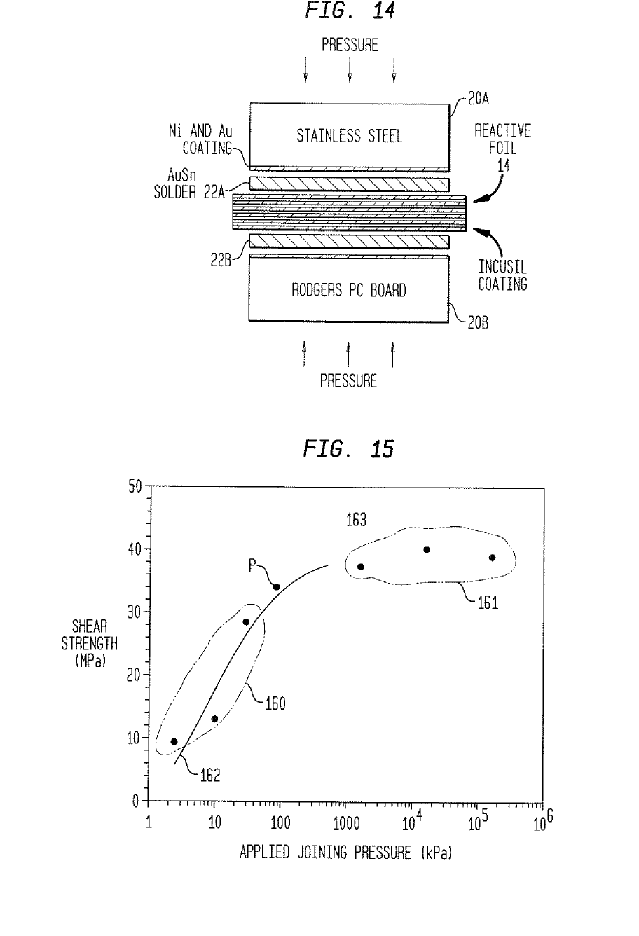

We now present specific examples of how to identify the critical applied joining pressure for different materials. As shown in FIG. 15, an Au plated stainless steel component 150 was joined onto an Au plated Rodgers PC board 151 using reactive Al/Ni foils 152 (100 μm) and AuSn solder layers 153 (25 μm). The dimension of the stainless steel component 150 is 0.5 mm×6 mm×25 mm and the dimension of Rodgers PC board 151 is 1 mm×15 mm×25 mm. The joining areas ranged between 18 to 30 mm². The joining process was performed at room temperature in air by igniting the reactive foils under pressure ranging from 2 kPa to 100 MPa. Shear strengths of the joints made with Al/Ni foils and AuSn solder layers are shown in FIG. 16. As the applied joining pressure increases from 2 kPa to 30 kPa, the joint shear strength increases dramatically from 10 to 30 MPa. Further increase in the applied joining pressure up to 100 MPa results in slight increase in joint shear strength, i.e. from 30 to 40 MPa. Thus a joint formed at 30% of the applied pressure has a strength of about 75% that producible using 100 MPa applied pressure. This plot shows that in order to join the Au plated stainless steel component onto an Au plated Rodgers PC board, the critical applied joining pressure is at the knee region around 30 kPa.

For many applications the critical applied pressure achieves a joint strength of at least 70% of the maximum obtainable by the practical maximum pressure that will not damage the materials being joined. As noted above, optimal pressures should not greatly exceed the critical pressure to avoid extrusion of braze and solder and consequent reduction in their thickness. And pressures should approach the critical pressure in order to obtain optimal wetting of the components being joined. Thus applied pressures are advantageously near the critical pressure, typically within ±5% of the critical pressure in a range producing about 70% to 85% of the maximum joint strength. For most applications joining metals, ceramics or other structural materials, the desirable critical pressure is less than about 10% maximum practical applied pressure. For such applications, the joint strength at the maximum practical pressure can be approximated by the joint strength at an applied pressure of about 100 MPa. The lower applied pressures facilitate the formation of large area joints with areas greater than 10 in².

To summarize, the flow of molten solder or braze material in reactive multilayer joints can be controlled by varying applied joining pressure, duration of melting of the solder or braze material, and the volumes of the molten solder or braze material available within the joints. Higher applied joining pressure enhances the flow of solder or braze material, improves the wetting condition, and thereby forms stronger joints. The applied joining pressure needs to approximately a critical value to enable enough flow of the molten solder or braze material and to form a good joint. Once the applied pressure reaches a critical value, the shear strength of the joints remains nearly constant. The thickness of the solder or braze layer in reactive joints decreases with increasing applied joining pressure. Duration of melting of the solder or braze material and the volumes of the molten solder or braze material available within the joint also affect the flow of the molten solder or braze in reactive joining. Longer duration and larger volumes of the molten solder or braze can enhance the flow of the solder or braze and result in a lower critical applied pressure. The duration of the melting of the solder or braze is determined by properties and geometries of the reactive foils, solder or braze materials, and components. Therefore the flow of the molten solder or braze in reactive joining can be controlled by varying the applied joining pressure, and properties and geometries of the reactive foil, solder or braze materials, and components, in order to maximize the performance of the resulting joints.

Thus the invention can be seen to include a method of joining first and second bodies of material using a reactive multiplayer foil and one or more layers or coatings of meltable joining material. It comprises disposing the reactive foil and meltable joining material between the bodies, pressing the bodies together against the foil and joining material, and initiating a self-propagating reaction through the foil to melt the joining material. The bodies are pressed together at or near a pressure in the knee region of the plot of joint strength (shear strength) versus the logarithm of applied pressure. Specifically, the plot is characterized by a lower pressure region with a relatively high slope, a higher pressure region with a relatively low slope and a knee region between the high slope region and the low slope region. The bodies should be pressed at an applied pressure in this knee region to obtain an optimal combination of near maximum joint strength, minimal solder flow, good wetting of the joining surfaces and high retention of joining material thickness with minimal extrusion of the material laterally through the joint.

Another way of specifying the desirable pressure used in the joining process is in terms of the joint strength that can be obtained at the maximum practical pressure that can be applied without damaging the bodies. The desirable pressure is substantially less than the maximum pressure but produces a joint having a shear strength equal to at least 70% of the shear strength at the maximum pressure. The desirable pressure is typically less than 20% of the maximum pressure and usually less than 10%.

For the typical joining of most bodies of metal, ceramic or other structural materials, the shear strength produced by an applied pressure of 100 MPa is a reasonable approximation of the shear strength at maximum practical pressure. So the desirable applied pressure is one substantially below 100 MPa that produces a joint having a shear strength equal to at least 70% of the shear strength at 100 MPa. For joining of typical microelectronic or semiconductor materials, the shear strength at maximum practical pressure can be approximated by the shear strength at about 1.0 MPa.

Yet another way of specifying the desirable pressure used in the process is in terms of the critical applied pressure separating the region of low strength-to-pressure slope from the region of low strength-to-pressure slope. The desirable applied pressure is advantageously within ±5% of this critical pressure.

Advantageous additional features of the above process are that the applied pressure be less than about 30 kPa and preferably less than about 20 kPa. The joining material has a thickness greater than about 0.5 micrometers, and the applied pressure is sufficiently low that the thickness is reduced by no more than 20% by the joining process. The melting of the joining materials has a duration greater than about 0.5 ms, and the bodies are joined over an area exceeding about 0.03 cm². The process is particularly advantageous in the formation of large area joints in excess of about 10 in².

It is understood that the above-described embodiments are illustrative of only a few of the many possible specific embodiments, which can represent applications of the invention. Numerous and varied other arrangements can be made by those skilled in the art without departing from the spirit and scope of the invention.

What is claimed is:

1. A method of joining first and second bodies of material using a reactive multilayer foil and one or more layers or coatings of meltable joining material comprising the steps of:
disposing the reactive foil and meltable joining material between the bodies;
pressing the bodies together against the foil and the joining material; and
initiating a self-propagating reaction through the foil to melt the joining material,
wherein a joining strength versus applied pressure plot for the joining process is characterized by a lower applied pressure region with a relatively high slope, a higher applied pressure region with a relatively low slope, and a knee region between the high slope and low slope, and wherein the bodies are pressed together at a pressure in the knee region.

2. The method of claim 1 wherein the pressure is about 30 kPa or less.

3. The method of claim 1 wherein the pressure is about 20 kPa or less.

4. The method of claim 1 wherein the meltable joining material comprises solder or braze material.

5. The method of claim 1 wherein the pressure is sufficiently low that the thickness of the joining materials is reduced by no more than 20% by the joining process.

6. The method of claim 1 wherein the melting of the joining materials has a duration greater that about 0.5 ms.

7. The method of claim 1 wherein the joining material has a thickness greater than about 0.5 micrometers.

8. The method of claim 1 wherein the bodies of material are joined over an area exceeding about 0.03 cm².

9. The method of claim 1 wherein the strength of the joint exceeds about 1 MPa.

10. The method of claim 1 wherein the joint has an area greater than about 10 in².

11. A method of joining first and second bodies of material using reactive multilayer foil and one or more layers or coatings of meltable joining material comprising the steps of:
disposing the reactive foil and the meltable joining material between the bodies;
pressing the bodies together against the foil and the joining material; and
initiating a self-propagating reaction through the foil to melt the joining material;
wherein the pressing is at a pressure substantially less than the maximum practical applied pressure that does not damage the bodies but provides a joint having a shear strength equal to at least 70% of the shear strength at the maximum practical applied pressure.

12. The method of claim 11 wherein the pressure is about 30 kPa or less.

13. The method of claim 11 wherein the pressure is about 20 kPa or less.

14. The method of claim 11 wherein the meltable joining material comprises solder or braze material.

15. The method of claim 11 wherein the pressure is sufficiently low that the thickness of the joining materials is reduced by no more than 20% by the joining process.

16. The method of claim 11 wherein the melting of the joining materials has a duration greater that about 0.5 ms.

17. The method of claim 11 wherein the joining material has a thickness greater than about 0.5 micrometers.

18. The method of claim 11 wherein the bodies of material are joined over an area exceeding about 0.03 cm².

19. The method of claim 11 wherein the strength of the joint exceeds about 1 MPa.

20. The method of claim 11 wherein the joint has an area greater than about 10 in².

21. A method of joining first and second bodies of material using reactive multilayer foil and one or more layers or coatings of meltable joining material comprising the steps of:
disposing the reactive foil and the meltable joining material between the bodies;
pressing the bodies together against the foil and the joining material; and
initiating a self-propagating reaction through the foil to melt the joining material;
wherein the pressing is at a pressure substantially less than 100 MPa but provides a joint having a shear strength equal to at least 70% of the shear strength formed using an applied pressure of 100 MPa.

22. The method of claim 21 wherein the pressure is about 30 kPa or less.

23. The method of claim 21 wherein the pressure is about 20 kPa or less.

24. The method of claim 21 wherein the meltable joining material comprises solder or braze material.

25. The method of claim 21 wherein the pressure is sufficiently low that the thickness of the joining materials is reduced by no more than 20% by the joining process.

26. The method of claim 21 wherein the melting of the joining materials has a duration greater that about 0.5 ms.

27. The method of claim 21 wherein the joining material has a thickness greater than about 0.5 micrometers.

28. The method of claim 21 wherein the bodies of material are joined over an area exceeding about 0.03 cm².

29. The method of claim 21 wherein the strength of the joint exceeds about 1 MPa.

30. The method of claim 21 wherein the joint has an area greater than about

31. A method of joining first and second bodies of material using reactive multilayer foil and one or more layers or coatings of meltable joining material comprising the steps of:
disposing the reactive foil and the meltable joining material between the bodies;
pressing the bodies together against the foil and the joining material; and
initiating a self-propagating reaction through the foil to melt the joining material;
wherein at least one of the first and second bodies comprises a microcircuit device or a semiconductor and the pressing is at a pressure low enough to eliminate solder spray from the joint but high enough to form a joint having a shear strength equal to at least 70% of the shear strength of the solder or braze material used to form the joint.

32. The method of claim 31 wherein the pressure is about 30 kPa or less.

33. The method of claim 31 wherein the pressure is about 20 kPa or less.

34. The method of claim 31 wherein the meltable joining material comprises solder or braze material.

35. The method of claim 31 wherein the pressure is sufficiently low that the thickness of the joining materials is reduced by no more than 20% by the joining process.

36. The method of claim 31 wherein the melting of the joining materials has a duration greater that about 0.5 ms.

37. The method of claim 31 wherein the joining material has a thickness greater than about 0.5 micrometers.

38. The method of claim 31 wherein the bodies of material are joined over an area exceeding about 0.03 cm².

39. The method of claim 31 wherein the strength of the joint exceeds about 1 MPa.

40. The method of claim 11 wherein the pressure is sufficient to cause wetting of the meltable joining material to the bodies and the foil.

41. The method of claim 21 wherein the pressure is sufficient to cause wetting of the meltable joining material to the bodies and the foil.

42. The method of claim 31, wherein the pressure is sufficient to cause wetting of the meltable joining material to the bodies and the foil.

43. A method of joining a first body and a second body comprising the steps of:
disposing a reactive multilayer foil and a meltable material between the first body and the second body;
applying a pressure to press the bodies, the reactive multilayer foil, and the meltable material together; and
initiating a self-propagating reaction through the reactive multilayer foil to melt the meltable material and form a joint, wherein the pressure is less than a maximum practical applied pressure and is sufficient to cause wetting of the meltable material to the bodies and the reacted multilayer foil.

44. The method of claim 43, wherein the joint has a shear strength greater than or equal to 70% of the shear strength of the weakest of the meltable material, the reacted multilayer foil, and the bodies.

45. The method of claim 43, wherein the pressure is sufficiently low that the thickness of the meltable material is reduced by no more than 20% by the joining process.
